(19) United States
(12) Patent Application Publication
(10) Pub. No.: US 2003/0037442 A1
(43) Pub. Date: Feb. 27, 2003

(54) Vegetation trimmer blade

(76) Inventor: Randy P. Lyon, Birmingham, AL (US)

Correspondence Address: L. F. Hilbers, Attorney at Law, Post Office Box 19393, Birmingham, AL, 35219-9393, US

(21) Appl. No.: 10/189,206

(22) Filed: Jul. 3, 2002

Related U.S. Application Data
(60) Provisional application No. 60/302,539, filed on Jul. 3, 2001.

(51) Int. Cl. A01D 34/416

(52) U.S. Cl. 30/276; 30/347

(57) ABSTRACT

A string holder for a rotary cutting head comprises a circular disk; a plurality of slots evenly spaced about a perimeter of the disk; and a mounting hole located at the circular disk's axis of rotation and a circle of string having a plurality of radial cutting lines, the circle interwoven in the slots.

### CROSS-REFERENCE TO RELATED APPLICATIONS

This application claims priority from U.S. Provisional Utility Application No. 60/302,539, which was filed on Jul. 3, 2001 by the same inventor.

### BACKGROUND OF THE INVENTION

Lawn and garden trimmers that utilize a monofilament cutting line are ubiquitous. Their light weight, power and effectiveness make them popular. Numerous improvements have been made over the years to make them more user-friendly. However, some of the improvements, which make the trimmers so easy to use, also contribute to the complexity of the trimmer's maintenance. An example is the rotary cutting head that contains a spool of cutting line that is always ready for use, such as the bump-head trimmer head. In operation, the bump-head trimmer head feeds additional cutting line from the trimmer's spool when the trimmer head is bumped against the ground. When this feature operates properly, it greatly speeds the trimming process since the user does not have to stop the trimmer to manually adjust the cutting line. However, there can be several obstacles to proper operation.

One of the reasons for the popularity of the bump-head feature is that the cutting line breaks frequently. This is because the cutting line receives a tremendous amount of abuse, not just from thrashing against rocks or concrete, but from typical lawn grass as well. This abuse leads to eventual failure of the exposed cutting line and the need to dispense more line from the bump-head's spool.

A contributor to this abuse experienced by the cutting line is the small number of filaments that are employed by the typical trimmer. Only one or two cutting lines protrude from the rotary cutting head in most cases; even more rarely, four cutting lines are employed. The fewer the number of cutting lines employed, the quicker the stress of use causes the cutting line's failure. Thus, the greater the number of cutting lines, the longer the cutting lines will last between failures.

Another drawback of the typical rotary cutting head is that refilling or replacing the spool of cutting line requires disassembly of the rotary cutting head. This process can be time-consuming and frustrating due to the tendency of the cutting line to unwind from the spool while it is being installed. The cutting line on typical trimmers is used rapidly, so an adequate supply must be kept at the ready. Manufacturers accomplish this by winding one or two very long and unwieldy pieces of cutting line onto a spool. For the typical user of such trimmers, it would be much more convenient to replace a number of manageable-length pieces of cutting line without the need for disassembling the rotary cutting head.

In addition to being long and unwieldy, when winding a cutting line onto a spool, the direction the line is wound onto the spool is critical. The rotation of the trimmer head in operation serves to aid in the deployment of additional lengths of cutting line from the spool. The automatic-feeding feature of a bump-head will not operate properly if the line is wound improperly.

Thus, there is a need for a rotary trimmer string holder that presents a large number of cutting lines from the rotary cutting head to distribute the workload of the cutting lines to a greater number of cutting lines, thereby favorably improving cutting line longevity. In addition, there is a need for an apparatus and method that permits the casual or unskilled user to easily and quickly replace the cutting lines on the string holder in the rotary cutting head without disassembly of the rotary cutting head. A number of short, manageable pieces of cutting line, or a small string assembly, is preferable to a single unwieldy piece. Further, there is a need for an easy-to-use string holder for a rotary cutting head that directly replaces the factory original, complex string holder or spool, and where the direction of rotation is irrelevant.

### SUMMARY

An advantage of the present Invention is the provision of a method and apparatus for a simple, quick, more convenient and less expensive and less frequent cutting line replacement for vegetation trimmers.

Another advantage of the present Invention is the provision of a method and apparatus for a vegetation trimmer having multiple cutting lines in excess of four (4).

In accordance with features of this Invention, a vegetation trimmer blade comprises an easily mountable cutting head and a disposable cutting line assembly easily attachable and detachable to the head.

### BRIEF DESCRIPTION OF THE DRAWINGS

The foregoing and other and further objects, features, and advantages of the Invention will be indicated in the appended Claims or will be apparent upon an understanding of the following more particular description of preferred embodiments as illustrated in the accompanying drawings in which a reference character refers to the same part throughout the various views as set forth in the two (2) Indices immediately following the list of Figures immediately below. The drawings are not necessarily to scale, emphasis instead being placed upon illustrating the principles of the Invention. Moreover, various objects, features, and advantages of the Invention not referred to herein will occur to one skilled in the art upon employment of the Invention in practice.

FIG. 1 is an isometric of the string holder with a circle of string, having multiple projecting cutting lines, woven onto the string holder in accordance with one embodiment of the invention;

FIG. 2 is a side view of the string holder in accordance with one embodiment of the invention; FIG. 3 is a top view of the string holder in accordance with one embodiment of the invention;

FIG. 4 is a top view of the circle of string, with multiple projecting cutting lines in accordance with one embodiment of the invention;

FIG. 5 is a side view of the circle of string with multiple projecting cutting lines in accordance with one embodiment of the invention;

FIG. 6 is a side view of the string holder with the circle of string, having multiple projecting cutting lines, woven onto the string holder in accordance with one embodiment of the invention;

FIG. 7. is a top view of the string holder with the circle of string, having multiple projecting cutting lines, woven onto the string holder in accordance with one embodiment of the invention;

FIG. 8 is an isometric of the string holder, with the circular string having multiple projection cutting arms, woven onto the string holder in accordance with one embodiment of the invention;

FIG. 9 is a top view of the string holder in accordance with one embodiment of the invention;

FIG. 10 is a side view of the string holder in accordance with one embodiment of the invention;

FIG. 11 is a top view of the string holder, with the circular string having multiple projection cutting arms, woven onto the string holder in accordance with one embodiment of the invention;

FIG. 12 is a side view of the string holder, with the circular string having multiple projection cutting arms, woven onto the string holder in accordance with one embodiment of the invention.

An Index of Reference Characters as well as an Index of Part Names follow:

### BRIEF DESCRIPTION OF THE DRAWINGS INDEX REFERENCE CHARACTERS

110 Tri-layer String Holder

112 Circle of String

114 Cutting Lines

116 Mounting Arbor

120 Upper Disk

122 Middle Disk

124 Lower Disk

126 Perimeter of Lower Disk

128 Perimeter of Upper Disk

130 Plurality of Gaps

140 Single Layer String Holder

142 Perimeter of the Single Layer String Holder

144 Slots of the Single Layer String Holder

146 Mounting Hole

### BRIEF DESCRIPTION OF THE DRAWINGS INDEX INDEX OF PART NAMES

112 Circle of String

114 Cutting Lines

124 Lower Disk

122 Middle Disk

116 Mounting Arbor

146 Mounting Hole

126 Perimeter of Lower Disk

142 Perimeter of the Single Layer String Holder

128 Perimeter of Upper Disk

130 Plurality of Gaps

140 Single Layer String Holder

144 Slots of the Single Layer String Holder

110 Tri-layer String Holder

120 Upper Disk

### DETAILED DESCRIPTION OF THE INVENTION

The device comprises an upper disk, a middle disk, a lower disk and a mounting arbor. The upper disk comprises a plurality of cleats projecting from a perimeter of the upper disk. The middle disk is attached to the bottom of the upper disk, and describes a circle. The lower disk comprises a plurality of cleats projecting from a perimeter of the lower disk, and is attached to the bottom of the middle disk. The mounting arbor is coextensive with the axes of rotation of the upper disk, the middle disk, and the lower disk, and facilitates attachment of the string holder to a power output shaft of a trimmer.

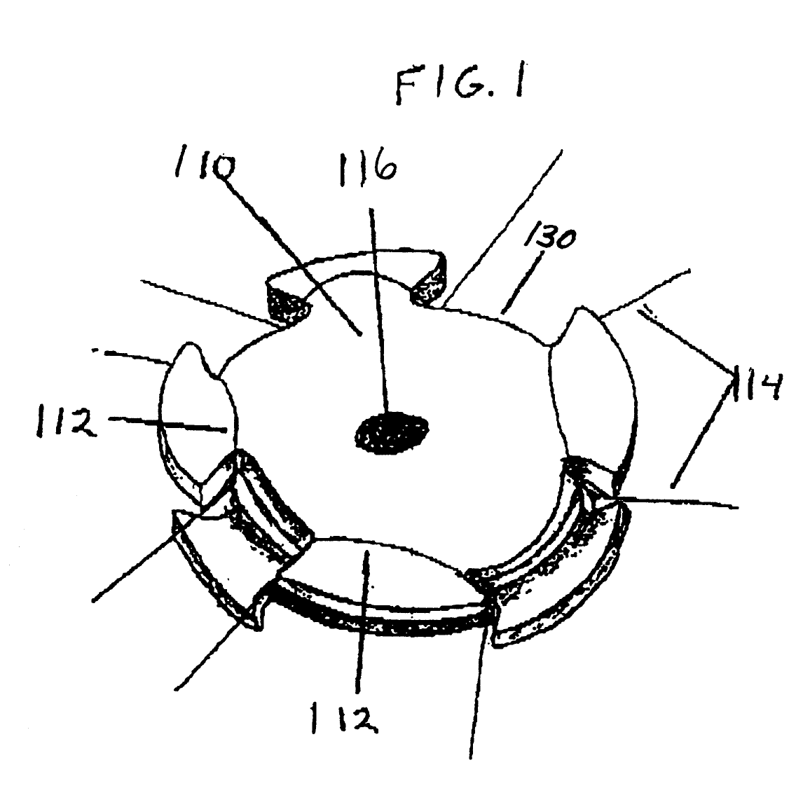

FIG. 1 is an isometric view of the string holder (110) with the circle of string (112), having multiple projecting cutting lines (114), woven onto the tri-layer string holder (110) in accordance with one embodiment of the invention. A mounting arbor (116) is located at the center of rotation, through the axes of the upper disk (120), the middle disk (122), and the lower disk (124). The mounting arbor (116) permits attachment of the string holder (110) to a power output shaft of a trimmer. The mounting arbor (116) may be a simple hole for a mounting bolt to pass through. In another embodiment, a plurality of cleats projecting from the perimeter of the lower disk (126) is equal to a plurality of cleats projecting from the perimeter of the upper disk (128). In another embodiment, the plurality of cleats of the upper disk (128) is completely out of phase with the plurality of cleats of the lower disk (126). When the string holder (110) is viewed from above or below, a plurality of gaps (130) are visible between the plurality of cleats of the upper disk (128) and the plurality of cleats of the lower disk (126). The plurality of gaps (130) are generally triangular in shape and taper to a point at the perimeters of the lower disk and upper disk. In another embodiment, the number of the plurality of cleats projecting from the perimeter of the upper disk and number of the plurality of cleats projecting from the perimeter of the lower disk is at least two. Two cleats permit at least four projecting cutting ends to be employed simultaneously. Increasing the number of cleats projecting from the perimeters of the upper disk (120) and the lower disk (124) provide more positions to secure and retain the circle of string (112), wherein the circle of string (112) has an even greater number of projecting cutting lines (114). Increasing the number of projecting cutting lines (114) serves to decrease the stresses placed on any single projecting cutting line, and to dramatically increase the useful life of all of the projecting cutting lines in a single circle of string.

The shape of the cleat projections and the orientation of the cleats on the upper disk and lower disk act to capture and retain the circle of string. The retention action of the cleat projections upon the circle of string prevents the circle of string from resisting the rotary motion of the cutting head. Thus the retention serves to keep the circle of string spinning at the same rate as the string holder (110). The middle disk (122) is attached to the bottom of the upper disk, and describes a circle. The middle disk serves to improve the retention capability of the cleat projections and to permit the circle of string to be woven more easily around the cleat projections of the upper disk and lower disk without binding.

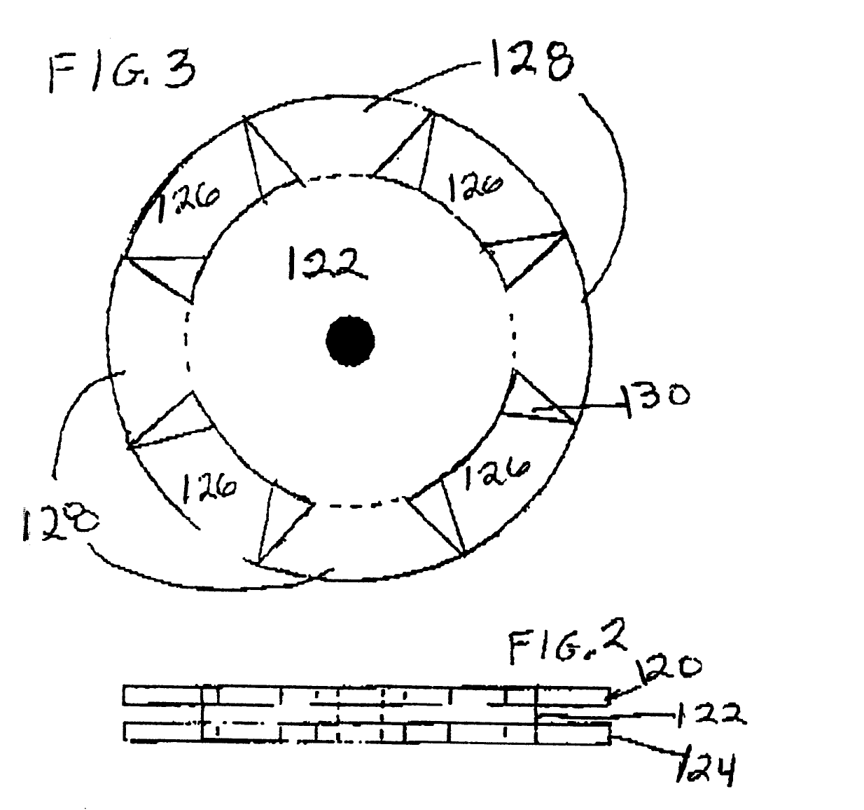

FIG. 2 is a side view of the string holder in accordance with one embodiment of the invention. The separation between the upper disk (120) and the lower disk (124) is shown. This gap represents the thickness of the middle disk (122). In practice, the middle disk (122) should be thick enough to permit a circle of string (112) to pass between the upper disk (120) and the lower disk (124). The thickness of the middle disk (122) may be slightly smaller than the thickness of the circle of string (112) if either, or both, the circle of string or the string holder is slightly flexible. The disks may be made separately and later bonded together, or may be formed as a single piece of material, like plastic or metal.

FIG. 3 is a top view of the string holder (110) in accordance with one embodiment of the invention. This view clearly shows the vertical interference between the cleats projecting from the upper disk (128) and the cleats projecting from the lower disk (126). Also visible are the plurality of gaps (130) between the cleats projecting from the upper disk (128) and the cleats projecting from the lower disk (126).

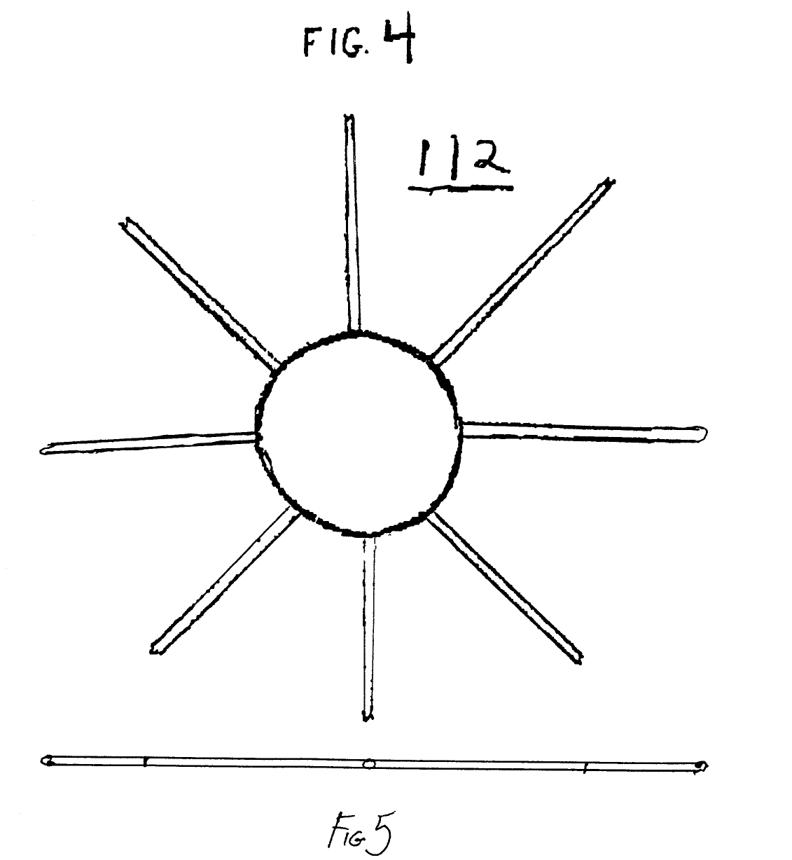

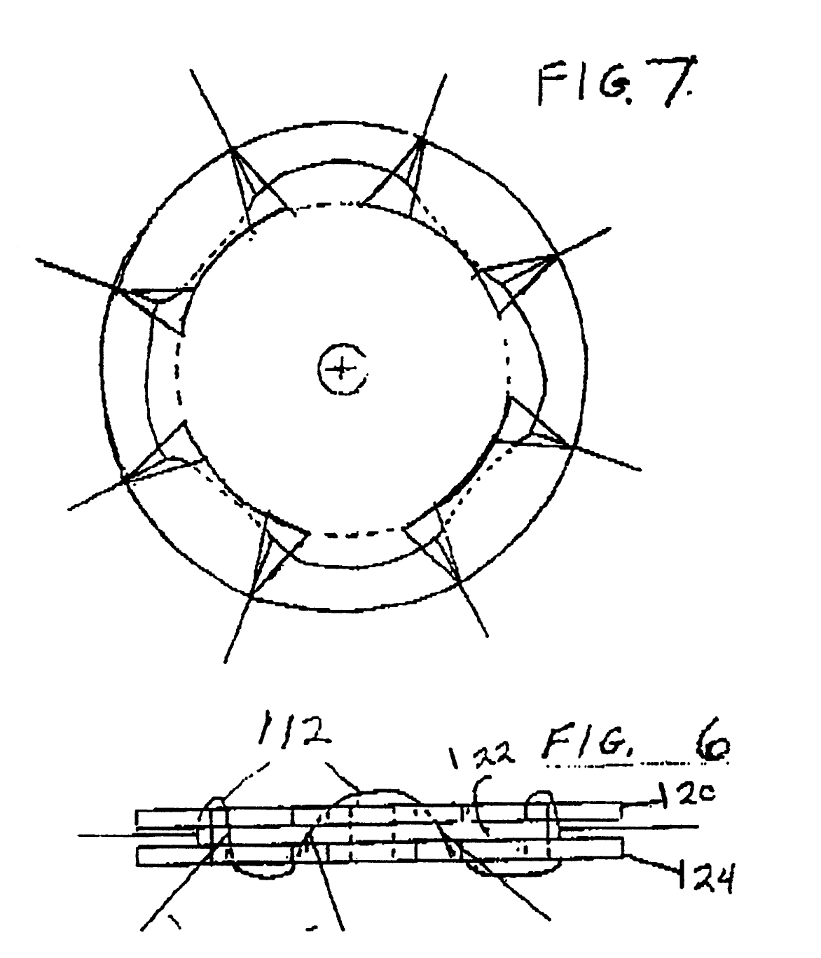

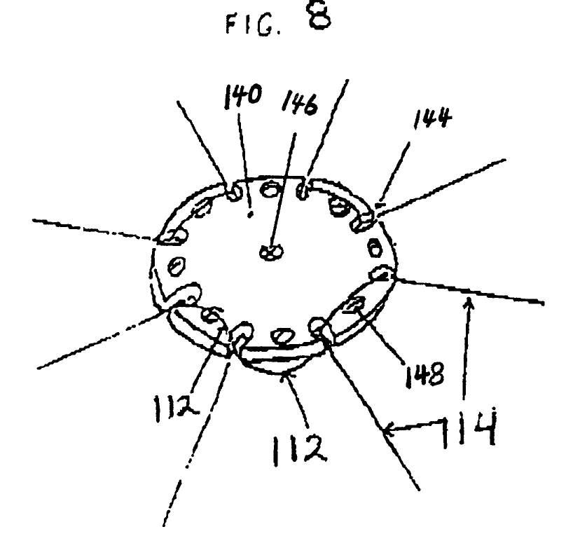

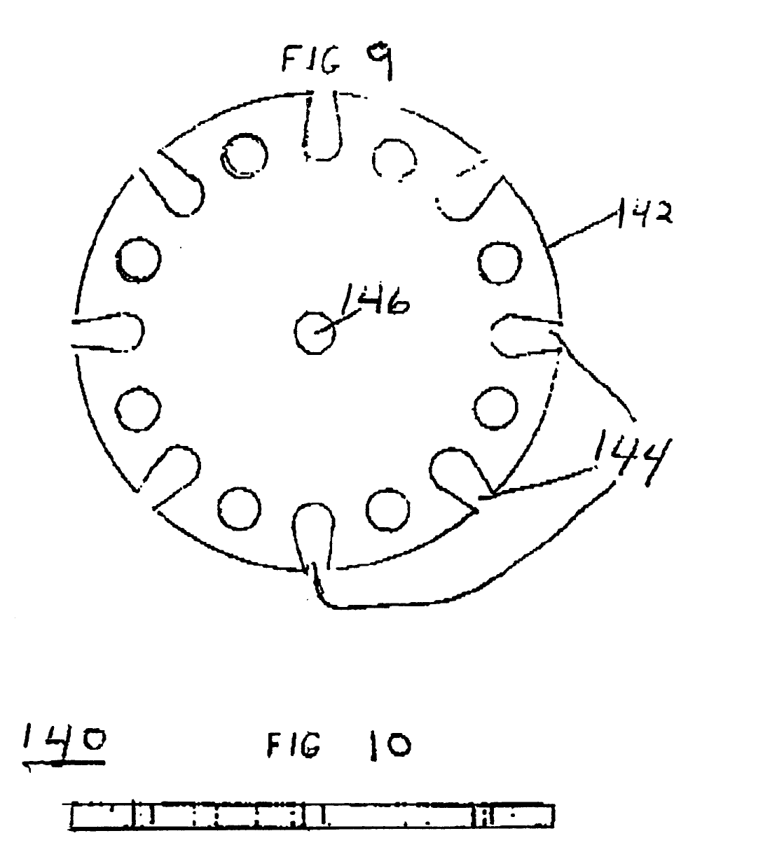

FIGS. 4 and 5 are a top view and a side view, respectively, of the circle of string (112), with multiple projecting cutting lines (114) in accordance with one embodiment of the invention. The circle of string (112) is a single, easily handled piece of a flexible, nonmetallic material, such as nylon monofilament. The multiple projecting cutting lines (114) may be made of a material different from the rest of the circle of string (112) The material must be strong lightweight and reasonably abrasion-resistant. Optimally, it should be inexpensive as well. In one embodiment, the circle of string (112) engages a plurality of cleats by weaving around the plurality of cleats at the perimeter of an upper disk (128) and a lower disk (126) of a tri-layer string holder (110). In another embodiment, the circle of string (112) engages a plurality of slots (144) by weaving around the plurality of slots (144) of a single layer string holder (140).

FIG. 6 is a side view of the string holder (110) with a circle of string (112), having multiple projecting cutting lines (114), woven onto the string holder (110) in accordance with one embodiment of the invention. This view shows the manner in which the circle of string (112) is woven around the upper cleats (128) and the lower cleats (126). This manner of securing the circle of string (112) to a string holder (110) requires no disassembly of the rotary cutting head to replace the cutting string.

FIG. 7 is a top view of the string holder (110) with the circle of string (112), having multiple projecting cutting lines (114), woven onto the string holder (110) in accordance with one embodiment of the invention. This view clearly shows the vertical interference between the cleat-shaped projections of the upper disk (128) and the cleat-shaped projections of the lower disk (126) and how they work together, separated by the middle disk (122), to retain a circle of string (112) properly in place.

FIG. 8 is an isometric of the single layer string holder (140) with the circle of string (112) having multiple projecting cutting arms (114), woven onto the string holder (140) in accordance with one embodiment of the invention. The device comprises a circular disk (140), a plurality of slots (144), evenly spaced about a perimeter (142) of the disk, and a mounting hole (146) located at the circular disk's (42) axis of rotation. In another embodiment, the plurality of slots (144) is an even number. In another embodiment, the plurality of slots (144) are narrower at the perimeter of the disk. This single-layer string holder (140) is designed to capture and retain a circle of string (112) in a compact package.

FIG. 9 is a top view of the string holder (140) in accordance with one embodiment of the invention. The plurality of slots (144) are shaped to capture and retain a circle of string (112) without permitting slippage of the circle of string (112) about the perimeter of the string holder (140).

FIG. 10 is a side view of the string holder (140) in accordance with one embodiment of the invention. The string holder (140) is a single-layer disk that is thick enough to cause a binding effect upon the circle of string (112) as the string is woven around the perimeter of the string holder (140).

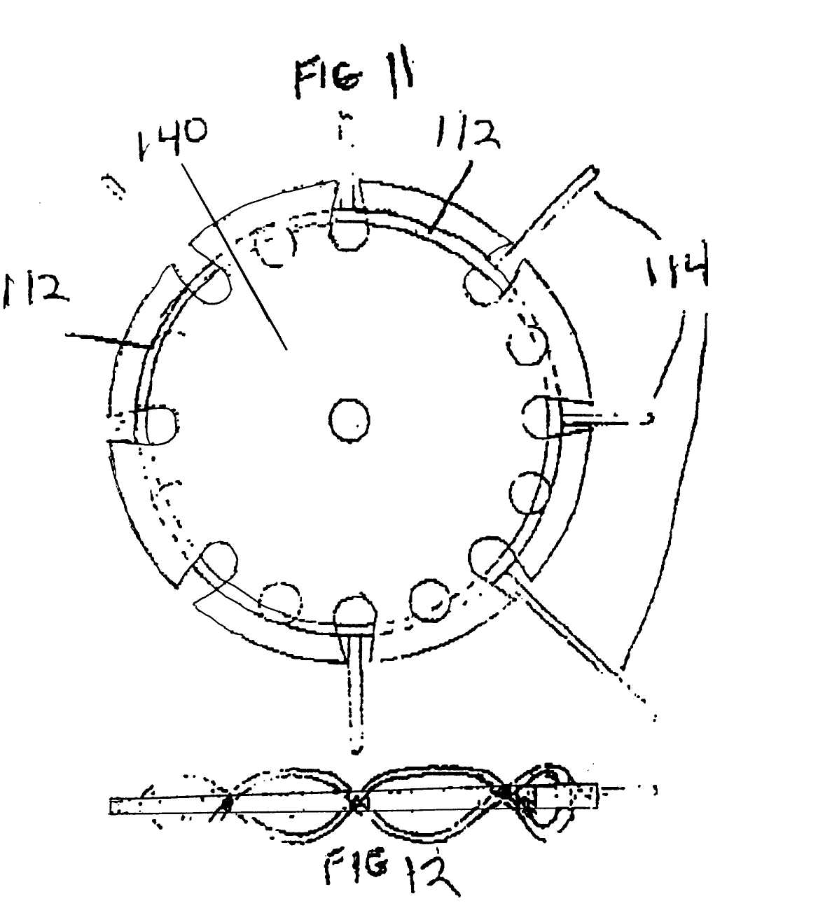

FIG. 11 is a top view of the string holder (140) with the circle of string (112) having multiple projection cutting arms (114), woven onto the string holder (140) in accordance with one embodiment of the invention. The circle of string (112) is captured within the plurality of slots about the perimeter of the string holder. In use, the plurality of projecting cutting arms (114) extend radially from the captured circle of string (112) as the string holder (140) rotates.

FIG. 12 is a side view of the string holder (140) with the circle of string (112) having multiple projection cutting arms (114), woven onto the string holder (140) in accordance with one embodiment of the invention. The circle of string (112) is woven through the plurality of slots (144), alternating sides of the string holder (140). The thickness of the string holder (140), in conjunction with the weaving pattern of the circle of string (112), securely retains the circle of string (112) upon the string holder (140).

While the Invention has been particularly shown and described with reference to the preferred embodiments thereof, it will be understood by those skilled in the art that various alterations modifications, and variations in form and detail may be made therein without departing from the spirit and scope on the Invention. Accordingly, it is intended to embrace all such alterations, modifications, and variations in the appended claims.

I claim:

1. A string holder for a rotary cutting head, comprising:
an upper disk, comprising a plurality of cleats projecting from a perimeter of the upper disk;
a middle disk, attached to the bottom of the upper disk, the middle disk describing a circle;
a lower disk, attached to the bottom of the middle disk, wherein the lower disk comprises a plurality of cleats projecting remain from a perimeter of the lower disk; and
a mounting arbor, coextensive with the axes of rotation of the upper disk, the middle disk, and the lower disk, and that permits attachment of the string holder to a power output shaft of a trimmer.

2. The string holder of claim 1, wherein the plurality of cleats projecting from the perimeter of the lower disk is equal to the plurality of cleats projecting from the upper disk.

3. The string holder of claim 2, whereby the plurality of cleats of the upper disk are completely out of phase with the cleats of the lower disk so that when viewed from above or below, a gap is formed between the cleats of the upper disk and the cleats of the lower disk, the gap being generally triangular in shape and tapering to a point at the perimeter of the lower disk and upper disk.

4. The string holder of claim 1, wherein the number of the plurality of wedges missing from the perimeter of the upper disk and number of the plurality of wedges missing from the perimeter of the lower disk is at least two.

5. A string holder for a rotary cutting head, comprising:
a circular disk;
a plurality of slots, evenly spaced about a perimeter of the disk; and
a mounting hole located at the circular disk's axis of rotation.

6. The string holder of claim 5, wherein the plurality of slots is an even number.

7. The string holder of claim 5, wherein the plurality of slots are narrower at the perimeter of the disk.

8. The string holder of claim 5, wherein a cutting line assembly is woven through the plurality of slots.

9. A cutting line assembly for a rotary cutting head comprising:
a flexible ring; and
a plurality of cutting lines projecting radially from the flexible ring.

10. The cutting line assembly of claim 9, wherein the flexible ring and the plurality of cutting lines are made of the same material.

11. The cutting line assembly of claim 9, wherein the flexible ring is attached to a string holder by weaving the flexible ring around a plurality of slots on a string holder.

12. The cutting line assembly of claim 9, wherein the flexible ring is attached to a string holder by weaving the flexible ring around a plurality of cleats on a string holder.

13. The cutting line assembly of claim 9, wherein the plurality of projecting cutting lines is at least one projecting cutting line.

14. A method of operating a string holder for a rotary cutting head, comprising the steps of:
(a) mounting the string holder to a power output shaft of a trimmer;
(b) weaving a circle of string through a plurality of openings along a perimeter of the string holder, whereby that each of the plurality of short cutting lines is secured to the string holder, whereby that each pair of terminal ends projects from the string holder, and whereby the terminal ends are evenly distributed around the perimeter of the string holder.

15. The method of claim 14, wherein the openings are a plurality of gaps formed between a plurality of cleats in an upper disk and a plurality of cleats in a lower disk.

16. The method of claim 14, wherein the openings are a plurality of slots around a perimeter of a circular disk.

17. The method of claim 14, wherein the circle of string comprises a plurality of short cutting lines.

18. The method of claim 17, wherein the plurality of short cutting lines are flexible and nonmetallic.
